(19) United States
(12) Patent Application Publication
(10) Pub. No.: US 2015/0133834 A1
(43) Pub. Date: May 14, 2015

(54) MASSAGE OFFICE CHAIR WITH THE MOVEMENT WHICH CAN BE ASSEMBLED AND DISASSEMBLED EASILY

(71) Applicant: Dongguan YuanJun Fitness Equipment Company Limited, Guangdong Province (CN)

(72) Inventor: Li RAN, Guangdong Province (CN)

(21) Appl. No.: 14/165,601

(22) Filed: Jan. 28, 2014

(30) Foreign Application Priority Data
Nov. 8, 2013 (CN) 201310552519.6

(51) Int. Cl. A61H 15/00

(52) U.S. Cl. CPC A61H 15/00
USPC 601/112

(57) ABSTRACT

An office chair allowing removing and mounting of massaging mechanism comprising a seat pad, a back-rest chair pad, a left armrest and a right armrest. There is a cavity inside the back-rest chair pad; a massaging mechanism is fitted inside the cavity; the massaging mechanism comprises a massaging head assembly and a driving assembly, both of which are mounted on a bottom case. The back-rest chair pad is furnished with at least 1 pair of rotary knobs. When the massaging mechanism is fitted inside the cavity and the rotary knobs rotate, press against the bottom case, and retain the massaging mechanism inside the cavity. To take out the massaging mechanism, just rotate the rotary knobs, and take out the massaging mechanism out of the cavity. The massaging mechanism may be replaced for various massaging effects that may relieve fatigues caused by sedentariness.

### BACKGROUND OF THE INVENTION

The present invention refers to a kind of human-body health-care massaging appliance, or more specifically, refers to a kind of office than equipped with massaging mechanism allowing easily removing and mounting.

As a kind of medium/high-class office equipment, the difference of different office chairs only lies in their exterior configuration and face fabrics, and they are utilized as nothing but chairs. Persons sitting in an similar office chairs for a long time may become fatigue easily, and ill-designed office chairs may lead to physical fatigue to a greater or less extent due to the inadequate functionality of the existing office chairs.

Nowadays, in order to fulfill the demands of people, the massaging functions of massaging armchairs are adopted to manufacture office chairs capable of massaging functions, which may massage relevant positions of the human body and release their fatigue. Their configuration mainly is composed of seat pad, armrests and backrest, and the front end side of most of the massaging armchair is equipped with a foot rest. The seat pad is used to support most of the user's body weight, the backrest is used to support his back, the armrest is used to hold his arms, and the foot rest is used to hold his feet. In the seat pad section, the iron rack plays a leading role in supporting the user. The seat pad rack is positioned on the under-frame that supports the overall weight of the massaging armchair. To ensure the comfortability of the user, the massaging armchair must be equipped with a certain posture regulation function. In other words, when the user lies on his back in a massaging armchair, the seat pad and backrest of the massaging armchair may move under the action of actuating mechanism, such that the angle between the user's legs and trunk may be changed so as to improve the comfortability of the user in process of massaging.

In addition, the massaging assemblies capable of massaging functions are usually positioned inside the back rest, which are used to massage the user's back. Most of the aforementioned office chairs capable of massaging functions are fabricated at one go, the massaging assemblies fitted inside the back rest cannot be removed, and a massaging assembly developing a fault after long-term operation cannot placed under repair before the back rest is opened. When the massaging assemblies are discarded, the office chair may not be capable of massaging function any more, and the user has no option but to purchase office chairs again, which means wasting of resources. Moreover, a kind of office chair is equipped with only a type of massaging effect, such that the user can only purchase an office chair again when he wants to change for other massaging effects.

### BRIEF SUMMARY OF THE INVENTION

The present invention is intended to overcome the defects existing in the prior art, and provide a kind of office chairs that allow easily removing and mounting of massaging mechanism. The massaging mechanisms of this kind of office chairs may be easily removed and mounted, the massaging mechanisms may be repaired and replaced, and massaging mechanisms capable of different massaging effects may be installed. In such a way, not only the resources may be saved, but also the application results may be improved.

The technical scheme of the present invention is achieved as follows: It comprises of a seat pad, a back-rest chair pad, and a left armrest and a right armrest fitted on the side edges of seat pad and back-rest chair pad. A seat pad rack and a pneumatic lifting rod are mounted below the seat pad, one end of the pneumatic lifting rod is fixed to the seat pad rack, and the other end is fixed securely to a 5-leg bracket. The improvements include: There is a cavity inside the back-rest chair pad, and a massaging mechanism is fitted inside the cavity. The massaging mechanism is composed of the massaging head assemblies used to massage the user's back, and the driving assemblies used to drive the massaging head assemblies. All massaging head assemblies and driving assemblies are mounted on a bottom case, the back-rest chair pad is furnished with at least of 1 pair of rotary knobs. When the massaging mechanism is fitted into the cavity, the rotary knobs rotate, press against the bottom case, and retain the massaging mechanism inside the cavity;

In the above-mentioned configuration, the back-rest chair pad is equipped with 2 pairs of rotary knobs that are symmetrically fastened onto both sides of the cavity in the back-rest chair pad;

In the above-mentioned configuration, a conductor is connected to the massaging mechanism, and the other end of the conducted is connected to a plug; a take-in box is positioned in the cavity and may take the conductor into the box, and a take-in box switch is mounted on the side edge of the back-rest chair pad;

In the above-mentioned configuration, the massaging head assembly is composed of an eccentric seat and a massaging head frame. The massaging head frame is mounted onto the eccentric seat, and a shim is fitted between the massaging head frame and eccentric seat. The massaging head frame is equipped with at least 2 massaging head seats and a massaging head cover fixed to the massaging head seat. The massaging head frame is also equipped with a transformer and a control. A lamp panel assembly is mounted between the massaging head seat and the massaging head cover. The lamp panel assembly is electrically connected to the transformer;

In the above-mentioned configuration, the driving assembly is composed of upper carriage board and lower carriage board. A motor, a worm mounted on the motor output shaft, a worm-geared worm wheel, and a worm-geared gear are mounted between the upper carriage board and lower carriage board. A massaging shaft is positioned at the center of the gear, and the top end of the massaging shaft is fixed in the above-mentioned eccentric seat;

In the above-mentioned construction, the upper carriage board is furnished with shaft sleeve A, the lower carriage board is furnished with shaft sleeve B, and the massaging shaft is arranged on shaft sleeve A and shaft sleeve B;

In the above-mentioned construction, the massaging shaft is also equipped with a pinion. The pinion is engaged with a small duplicate gear, and the small duplicate gear is engaged with a big duplicate gear. A rack is fixed to the bottom case. The big duplicate gear is engaged with the rack. When the pinion rotates, it drives the big duplicate gear, such that the driving assembly and massaging head assemblies are driven to conduct up-and-down movement on the bottom case;

In the above-mentioned construction, the lower-ends of 5-leg bracket are furnished with castors;

In the above-mentioned construction, the left armrest is equipped with a control panel furnished with multiple control buttons;

In the above-mentioned construction, a headrest is fixed above the back-rest chair pad.

The present invention has the beneficial effects as follows: There is a cavity inside the back-rest chair pad, and a massaging mechanism is fitted inside the cavity. The back-rest chair pad is furnished with rotary knobs. When the massaging mechanism is fitted into the cavity, the rotary knobs rotate, press against the bottom case, and retain the massaging mechanism inside the cavity. With such a construction, the massaging mechanism of the present invention may be easily repaired and replaced. To take out the massaging mechanism, just turn the rotary knobs, and take the massaging mechanism out of the cavity. The massaging mechanism may be replaced for various massaging effects that may relieve the fatigue caused by sedentariness. In addition, a take-in box is positioned in the cavity and may take the conductor into the box, and a take-in box switch is mounted on the side edge of the back-rest chair pad. When massaging function is not required, the user may pull the plug out of the socket, and push the take-in box switch to take the conductor into the take-in box. The present invention allows very easy operation.

### BRIEF DESCRIPTION OF THE DRAWINGS

FIG. 1 gives a stereoscopic sketch of the present invention;

FIG. 2 gives an explosive view of the present invention;

FIG. 3 shows the operating panel the present invention

FIG. 4, FIG. 5 and FIG. 7 show the sketch of back-rest chair pad;

FIG. 6 shows a close-up view of place A indicated in FIG. 5;

FIG. 8 shows a stereoscopic sketch massaging mechanism of the present invention;

FIG. 9 shows an explosive view of massaging head assembly and driving assembly of massaging mechanism of the present invention.

### DETAILED DESCRIPTION OF THE INVENTION

Based on the figures and embodiments, the present invention is further described in the following.

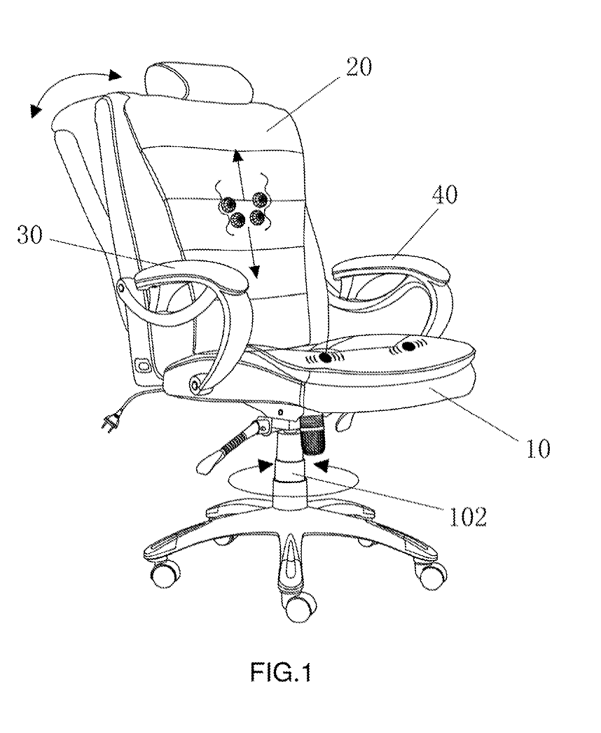

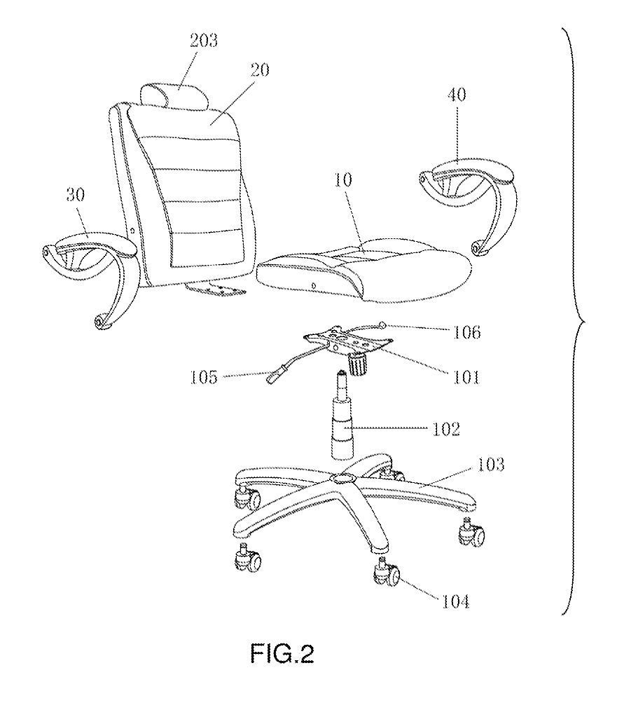

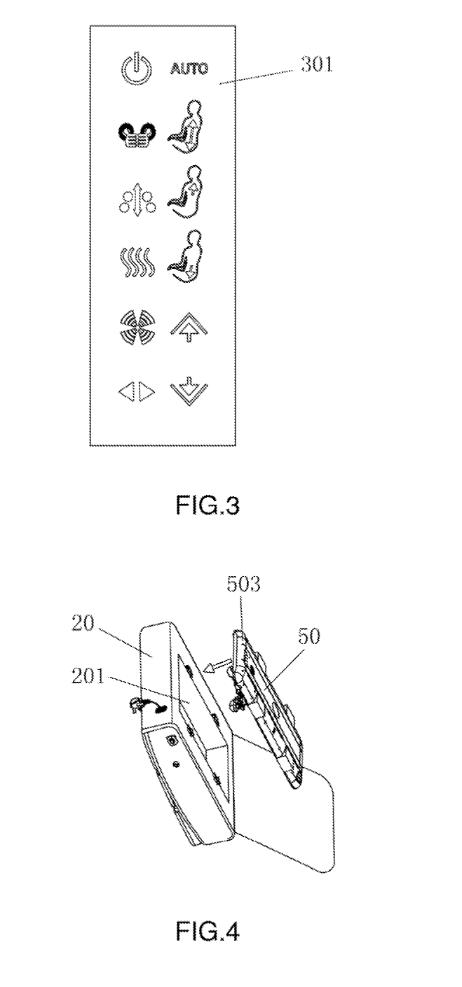

As shown in FIG. 1 and FIG. 2, the present invention discloses an office chair equipped with a massaging mechanism allowing easily removing and mounting. The office chair is composed of seat pad 10, back-rest chair pad 20 left armrest 30 and right armrest 40 mounted on the side edges of seat pad 10 and back-rest chair pad 20; Of which, left armrest 30 is equipped with control panel 301 as shown in FIG. 3; the control panel 301 is equipped with control buttons for various functions, such as power-supply control button, massage-function mode button etc. As shown in FIG. 2, headrest 203 is mounted above back-rest chair pad 20, cushion rack 101 and pneumatic lifting rod 102 are mounted below seat pad 10, one end of pneumatic lifting rod 102 is attached to cushion rack 101, and the end is attached to 5-leg bracket 103. The lower-end of 5-leg bracket is furnished with castor 104 to enable movement of the office chair. Cushion rack 101 is furnished with lever 105 used to adjust the telescoping of pneumatic lifting rod 102 so as to adjust the height of seat pad 10.

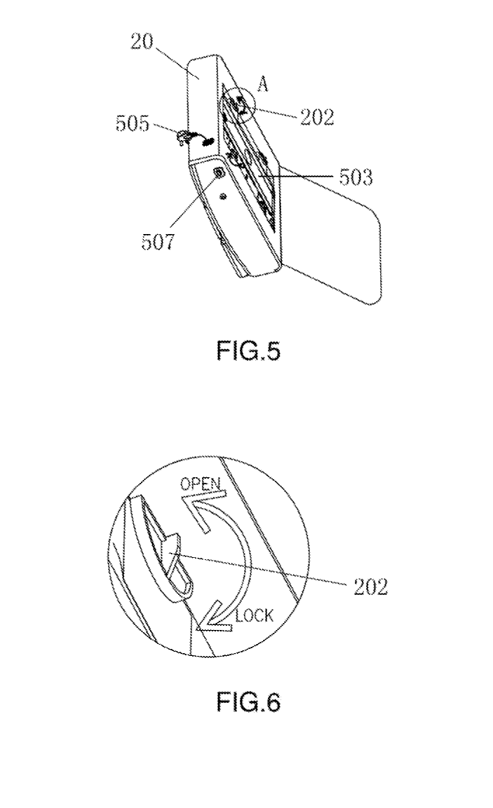

As shown in FIGS. 4 to 6, there is cavity 201 inside back-rest chair pad 20. The cavity 201 is equipped with massaging mechanism 50. Massaging mechanism 50 is composed of massaging head assembly 501 used to massage the user's back and driving assembly 502 used to drive massaging head assembly 501. Both massaging head assembly 501 and driving assembly 502 are mounted on bottom case 503. In the embodiment, as shown in FIG. 5 and FIG. 6, back-rest chair pad 20 is equipped with 2 pairs of rotary knobs 202. The 2 pairs of rotary knobs 202 are symmetrically mounted on both sides of cavity 201 of back-rest chair pad 20. When massaging mechanism core 50 is fitted into cavity 201, rotary knobs 202 rotate, press against bottom case 503, and fix massaging mechanism 50 inside cavity 201. In addition, as shown in FIG. 7, one end of conductor 504 is connected to massaging mechanism 50, and the other end of conductor 504 is connected to plug 505. Take-in box 506 is fitted inside cavity 501, which may take conductor 504 into take-in box 506. Take-in box switch 507 is mounted on the side edge of back-rest chair pad 20.

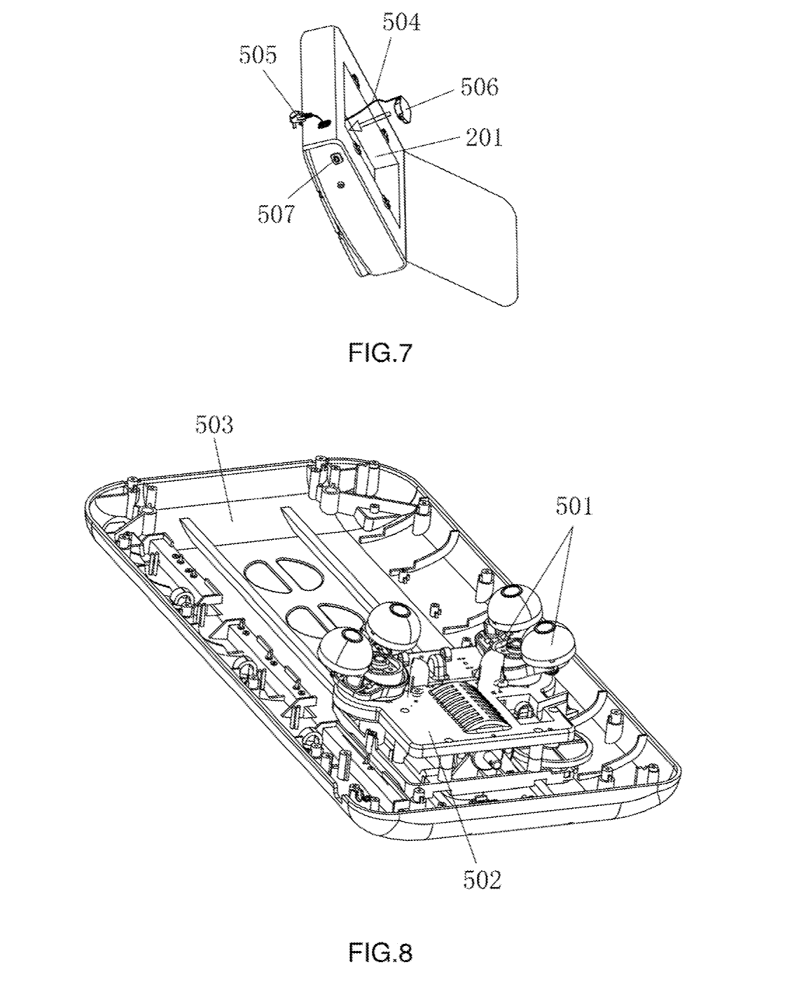

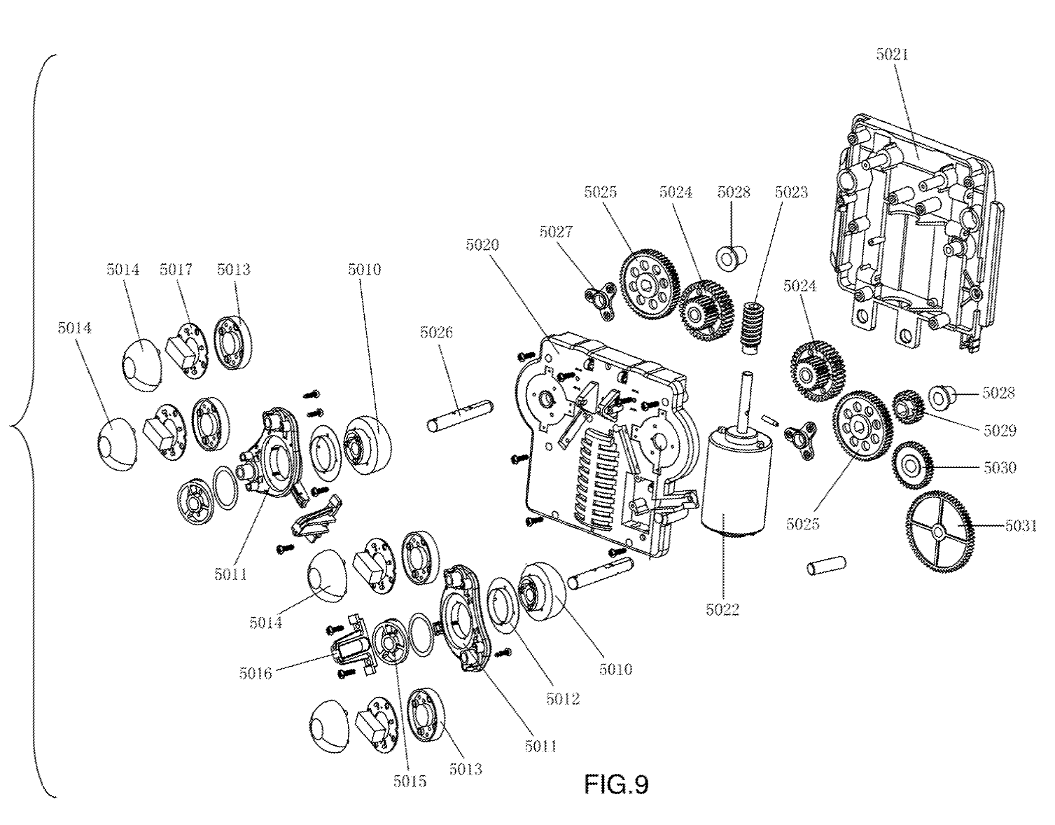

As shown in FIG. 8 and FIG. 9, massaging head assembly 501 is composed of eccentric seat 5010 and a massaging head frame 5011. The massaging head frame 5011 is mounted onto the eccentric seat 5010, and a shim 5012 is fitted between the massaging head frame 5011 and eccentric seat 5010. Massaging head frame 5011 is equipped with at least 2 massaging head seats 5013 and massaging head cover 5014 fixed to massaging head seat 5013. Massaging head frame 5011 is also equipped with a transformer 5015 and a control 5016. A lamp panel assembly 5017 is mounted between massaging head seat 5013 and massaging head cover 5014. The lamp panel assembly 5017 is electrically connected to transformer 5015.

Furthermore, driving assembly 502 is composed of upper carriage board 5020 and lower carriage board 5021. Motor 5022, worm 5023 mounted on the motor output shaft, worm-geared worm wheel 5024, and gear 5025 geared by worm wheel 5024 are mounted between upper carriage board 5020 and lower carriage board 5021. Massaging shaft 5026 is positioned at the center of the gear, and the top end of massaging shaft 5026 is fixed in the above-mentioned eccentric seat 5010; The above-mentioned upper carriage board 5020 is furnished with shaft sleeve A 5027, lower carriage board 5021 is furnished with shaft sleeve B 5028, and massaging shaft 5026 is mounted on shaft sleeve A 5027 and shaft sleeve B 5028. In addition, massaging shaft 5026 is also equipped with pinion 5029. Pinion 5029 is engaged with small duplicate gear 5030, and small duplicate gear 5030 is engaged with big duplicate gear 5031. A rack is fixed to bottom case 503. Big duplicate gear 5031 is engaged with the rack. When pinion 5029 rotates, it drives big duplicate gear 5031, such that driving assembly 502 and massaging head assembly 501 are driven to conduct up-and-down movement on bottom case 503.

Based on the above-mentioned configuration adopted for the present invention, there is cavity 201 inside back-rest chair pad 20, and massaging mechanism 50 is fitted inside cavity 201. Back-rest chair pad 20 is fitted with rotary knobs 202. When the massaging mechanism 50 is fitted into cavity 201, the rotary knobs 202 rotates, presses against bottom case 503, and fastens the massaging mechanism 50 inside cavity 201. With such a construction, massaging mechanism 50 of the present invention may be easily repaired and replaced. To take out massaging mechanism 50, just turn rotary knobs 202, and take massaging mechanism 50 out of the cavity. Massaging mechanism 50 may be replaced for various massaging effects that may relieve the fatigue caused by sedentariness. Take-in box 506 is positioned in cavity 201, and take-in box switch 507 is mounted on the side edge of back-rest chair pad 20. When massaging function is not required, the user may pull plug 505 out of the socket, and push take-in box switch 507 to take conductor 504 into take-in box 506. The present invention allows very easy operation.

For the above preferred embodiment, object of the present invention, the technical solutions and advantages described in more detail, shall be understood that the above description is only preferred embodiments of the present invention only, not intended to limit the present invention, where In the present invention within the spirit and principles, any modification, equivalent replacement, improvement, etc., should be included in the present invention within the scope of protection.

What is claimed is:

1. A kind of office chairs that allow easily removing and mounting of massaging mechanism (the office chair is composed of a seat pad, a back-rest chair pad, and a left armrest and a right armrest fitted on the side edges of seat pad and back-rest chair pad. A seat pad rack and a pneumatic lifting rod are mounted below the seat pad, one end of the pneumatic lifting rod is fixed to the seat pad rack, and the other end is fixed securely to a 5-leg bracket), featured in that there is a cavity inside the back-rest chair pad, a massaging mechanism is fitted inside the cavity; the massaging mechanism is composed of a massaging head assembly used to massage the user's back and a driving assembly used to drive the massaging head assembly; both the massaging head assembly and driving assembly are mounted on a bottom case. The back-rest chair pad is furnished with at least 1 pair of rotary knobs. When the massaging mechanism is fitted inside the cavity, the rotary knobs rotate, press against the bottom case, and retain the massaging mechanism inside the cavity.

2. A kind of office chair equipped with a massaging mechanism allowing easy removal and mounting as claimed in claim 1, featured in that: the back-rest chair pad is furnished with 2 pairs of rotary knobs that are symmetrically mounted on both sides of cavity inside the back-rest chair pad.

3. A kind of office chair equipped with a massaging mechanism allowing easily removing and mounting as claimed in claim 1, featured in that a conductor is connected to the massaging mechanism, and the other end of the conducted is connected to a plug; a take-in box is positioned in the cavity and may take the conductor into the box, and a take-in box switch is mounted on the side edge of the back-rest chair pad.

4. A kind of office chair equipped with a massaging mechanism allowing easily removing and mounting as claimed in claim 1, featured in that: The massaging head assembly is composed of an eccentric seat and a massaging head frame. The massaging head frame is mounted onto the eccentric seat, and a shim is fitted between the massaging head frame and eccentric seat. The massaging head frame is equipped with at least 2 massaging head seats and a massaging head cover fixed to the massaging head seat. The massaging head frame is also equipped with a transformer and a control. A lamp panel assembly is mounted between the massaging head seat and the massaging head cover. The lamp panel assembly is electrically connected to the transformer.

5. A kind of office chair equipped with a massaging mechanism allowing easily removing and mounting as claimed in claim 4, featured in that: the driving assembly is composed of upper carriage board and lower carriage board. A motor, a worm mounted on the motor output shaft, a worm-geared worm wheel, and a worm-geared gear are mounted between the upper carriage board and lower carriage board. A massaging shaft is positioned at the center of the gear, and the top end of the massaging shaft is fixed in the above-mentioned eccentric seat;

6. A kind of office chair equipped with a massaging mechanism allowing easily removing and mounting as claimed in claim 5, featured in that: The upper carriage board is furnished with shaft sleeve A, the lower carriage board is furnished with shaft sleeve B, and the massaging shaft is arranged on shaft sleeve A and shaft sleeve B.

7. A kind of office chair equipped with a massaging mechanism allowing easily removing and mounting as claimed in claim 5, featured in that: The massaging shaft is also equipped with a pinion. The pinion is engaged with a small duplicate gear, and the small duplicate gear is engaged with a big duplicate gear. A rack is fixed to the bottom case. The big duplicate gear is engaged with the rack. When the pinion rotates, it drives the big duplicate gear, such that the driving assembly and massaging head assemblies are driven to conduct up-and-down movement on the bottom case.

8. A kind of office chair equipped with a massaging mechanism allowing easily removing and mounting as claimed in claim 1, featured in that: the lower-ends of 5-leg bracket are furnished with castors.

9. A kind of office chair equipped with a massaging mechanism allowing easily removing and mounting as claimed in claim 1, featured in that: The left armrest is equipped with a control panel furnished with multiple control buttons.

10. A kind of office chair equipped with a massaging mechanism allowing easily removing and mounting as claimed in claim 1, featured in that: A headrest is fixed above the back-rest chair pad.
